(19) United States
(12) Patent Application Publication
(10) Pub. No.: US 2004/0036832 A1
(43) Pub. Date: Feb. 26, 2004

(54) Liquid crystal device, manufacturing method thereof, and electronic apparatus

(75) Inventor: Yoichi Momose, Matsumoto-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/621,611

(22) Filed: Jul. 18, 2003

(30) Foreign Application Priority Data
Aug. 5, 2002 (JP) 2002-227677

(51) Int. Cl. G02F 1/1339

(52) U.S. Cl. 349/153

(57) ABSTRACT

To provide a liquid crystal device which can be cured in a relatively short period of time and which has a sufficient adhesion strength. A liquid crystal display device 100 has a liquid crystal layer provided between a pair of substrates 10 and 20, and a sealing material 52 which bonds the pair of substrates 10 and 20 to each other and which encloses the liquid crystal layer between the above substrates. The sealing material 52 contains a photocurable component and a thermosetting component, in which the maximum curing rate of the photocurable component is set to 60% to 95%, and the curing rate of the thermosetting component is set to 60% to 90%.

### BACKGROUND OF THE INVENTION

1. Field of Invention

The present invention relates to liquid crystal devices, manufacturing methods thereof, and electronic apparatuses using the liquid crystal devices mentioned above. More particularly, the invention relates to a liquid crystal device provided with a sealing material on at least one of substrates enclosing a liquid crystal layer.

2. Description of Related Art

Some related art liquid crystal devices have a structure in which lower and upper substrates are bonded to each other with a sealing material provided at the peripheries thereof, and in which a liquid crystal layer is enclosed between the substrates. As the sealing materials, in general, for example, a thermosetting resin cured by heating and a photocurable resin cured by ultraviolet ray irradiation can be used.

However, in general, the strength of a photocurable resin may be lower than that of a thermosetting resin in many cases. On the other hand, since taking a curing time longer than that of a photocurable resin in many cases, a thermosetting resin is not preferable in view of production efficiency.

In addition, for example, when an epoxy resin is used as a curable resin, as a curing agent for the epoxy resin, an inorganic acid used for a photocurable resin and an organic acid used for a thermosetting resin can be used. When the inorganic acid for a photocurable resin is used as a sealing agent for a liquid crystal device, the inorganic acid is dissolved in liquid crystal and may cause degradation in display quality, such as decrease in resistivity of the liquid crystal or irregular threshold values, in some cases, and hence the organic acid for a thermosetting resin is preferably used for a liquid crystal device. When the organic acid for a thermosetting resin is used as a curing agent, since the organic acid component is bonded to an epoxy resin during curing reaction and is not dissolved in liquid crystal, the degradation in display quality may not occur; however, compared to the case of a photocurable resin, the curing time is disadvantageously increased.

In addition, when an acrylic resin is used as a photocurable resin, the adhesion strength thereof is small as compared to that of an epoxy resin. Hence, a problem may arise in some cases that a liquid crystal device in which the acrylic resin is only used as a sealing material, does not have enough strength.

### SUMMARY OF THE INVENTION

The present invention addresses the above and/or other problems, and provides a liquid crystal device in which curing can be performed in a relatively short period of time and which has a sufficient adhesion strength, a manufacturing method thereof, and an electronic apparatus using the liquid crystal device mentioned above.

In order to address or achieve the above, a liquid crystal device of the present invention includes: a pair of substrates; a liquid crystal layer provided therebetween; and a sealing material bonding said pair of substrates to each other and enclosing the liquid crystal layer between said pair of substrates. In the liquid crystal device described above, the sealing material contains a photocurable component and a thermosetting component, the photocurable component has a maximum curing rate in the range of from 60% to 95%, and the thermosetting component has a curing rate in the range of from 60% to 90%.

In the liquid crystal device described above, since the sealing material contains the thermosetting component and the photocurable component, the maximum curing rate of the photocurable component is in the range of from 60% to 95%, and the curing rate of the thermosetting component is in the range of from 60% to 90%, compared to the case in which the thermosetting component is only used, the curing can be performed in a short period of time, and in addition, the strength can be increased as compared to the case in which the photocurable component is only used. Furthermore, sufficient adhesion strength and sealing properties can be obtained since the curing rate of each component is enhanced or optimized. When the maximum curing rate of the photocurable component is more than 95%, or the curing rate of the thermosetting component is more than 90%, the sealing material may become fragile, and the adhesion strength may decrease in some cases. In addition, when the maximum curing rate of the photocurable component is less than 60%, the uniformity of the cell gap (distance between the substrates) may not be maintained in some cases. Furthermore, when the curing rate of the thermosetting component is less than 60%, moisture is likely to penetrate into the sealing material, and as a result, the reliability of the liquid crystal device may be decreased in some cases. In the present invention, the curing rate indicates the rate of change in a functional group involved in the curing before and after the reaction thereof.

The sealing material described above may contain a photocurable component and a thermosetting component in the same molecular chain. When the resin containing the individual components in the same molecular chain is used, it becomes simple from a manufacturing point of view since two uncured components are not necessary to be mixed together, and in addition, degradation in reliability of the sealing material can be reduced or avoided which occurs when two components incompatible in solubility with each other are used. In addition, the sealing material may not contain the individual components in the same molecular chain and may be formed of a mixture of a photocurable resin and a thermosetting resin. Furthermore, the sealing material may include a resin containing the photocurable component, a resin containing the thermosetting component, and a resin containing the photocurable component and the thermosetting component in the same molecular chain.

The photocurable component may include an acrylic group and/or a methacrylic group, and on the other hand, the thermosetting component may include an epoxy group. In addition, for the thermosetting component including an epoxy group, for example, an organic acid may be used as a curing agent.

A method for manufacturing the liquid crystal device described above may include the following steps, for example. The method manufactures a liquid crystal device having a liquid crystal layer provided between a pair of substrates. The method includes applying an adhesive onto at least one of surfaces of the pair of substrates to form a closed frame shape in a region of the surface thereof; disposing spacers on at least one of surfaces of the pair of substrates; dripping liquid crystal onto at least one of surfaces of the pair of substrates after the adhesive and the spacers are disposed; bonding the pair of substrates to each other after the liquid crystal is dripped; and curing the adhesive after the bonding is performed. In the method described above, the adhesive is an uncured material which is formed to a sealing material described above by curing.

In addition, in another method for manufacturing a liquid crystal device provided with a liquid crystal inlet as describe below, the liquid crystal device is manufactured by injecting liquid crystal through the liquid crystal inlet provided in the sealing material after substrates are bonded to each other. That is, the method manufactures a liquid crystal device, in accordance with another aspect of the present invention, that includes a liquid crystal device comprising a liquid crystal layer provided between a pair of substrates. The method includes: applying an adhesive onto at least one of surfaces of the pair of substrates to form a frame shape provided with a liquid crystal inlet; disposing spacers on at least one of surfaces of the pair of substrates; bonding the pair of substrates to each other after the adhesive and the spacers are disposed; curing the adhesive after the bonding is performed, and injecting liquid crystal inside the adhesive through the liquid crystal inlet. As the adhesive described above, an uncured material is used to form a sealing material described above by curing.

By each of the manufacturing methods described above, the liquid crystal device having the sealing material described above can be provided. In particular, in the present invention, the curing of the adhesive may include at least a light irradiation substep of curing the photocurable component and a heating substep of curing the thermosetting component.

In the light irradiation substep, the amount of light irradiation is preferably in the range of from 1,000 to 6,000 mJ/cm². When the amount of light irradiation is less than 1,000 mJ/cm², sufficient curing may not be carried out in some cases, and in addition, when the amount of light irradiation is more than 6,000 mJ/cm², the resin may be degraded in some cases.

In addition, in the heating substep, the heating temperature and the heating time are preferably set to 60 to 160° C. and 20 to 300 minutes, respectively. When the heating temperature is less than 60° C., or when the heating time is less than 20 minutes, sufficient curing may not be carried out in some cases, and when the heating temperature is more than 160° C., or when the heating time is more than 300 minutes, the resin may be degraded in some cases.

An electronic apparatus of the present invention includes the liquid crystal device described above as a display device. Since the liquid crystal device of the present invention is provided, a highly reliable electronic apparatus having a small number of defect occurrences can be provided.

### BRIEF DESCRIPTION OF THE DRAWINGS

FIG. 1 is a plan view showing a liquid crystal display device according to an exemplary embodiment of the present invention, in which the liquid crystal display device formed of various constituent elements is viewed from a counter substrate side;

FIG. 2 is a cross-sectional view taken along plane H-H′ shown in FIG. 1;

FIG. 3 is a schematic circuit diagram of various elements, wires, and the like provided in a plurality of pixels arranged in a matrix in an image display region of the above liquid crystal display device;

FIG. 4 is a partial, enlarged, cross-sectional view of the above liquid crystal display device;

FIG. 5 is a plan view showing an exemplary modification of the liquid crystal display device shown in FIG. 1;

FIG. 6 is a perspective view showing an example of an electronic apparatus using a liquid crystal display device of the present invention;

FIG. 7 is a perspective view showing another example of an electronic apparatus using the liquid crystal display device of the present invention;

FIG. 8 is a perspective view showing still another example of an electronic apparatus using the liquid crystal display device of the present invention;

FIG. 9 is a graph showing the relationship between the curing rate and the amount of UV irradiation for an acrylic component.

### DETAILED DESCRIPTION OF PREFERRED EMBODIMENTS

Exemplary embodiments of the present invention are described below with reference to figures.

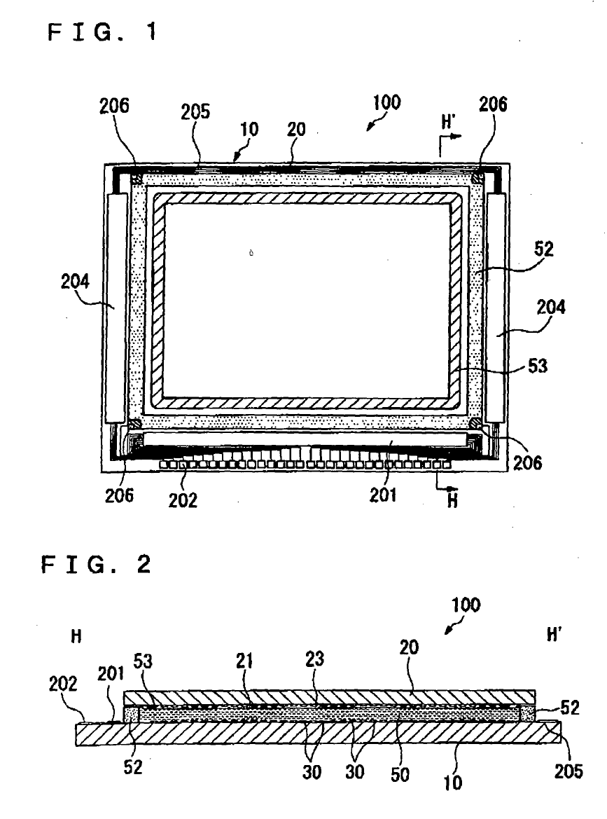

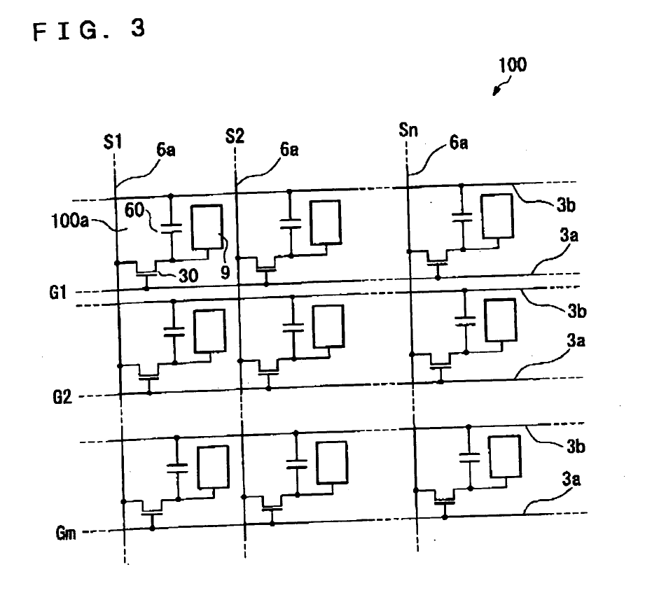

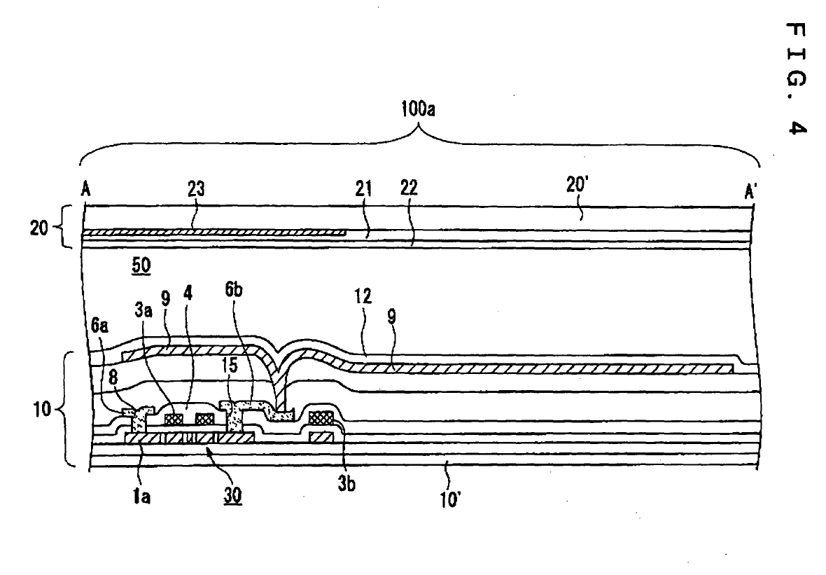

FIG. 1 is a plan view showing a liquid crystal display device as an exemplary embodiment of a liquid crystal device according to the present invention, in which the liquid crystal display device formed of various constituent elements is viewed from a counter substrate side, and FIG. 2 is a cross-sectional view taken along plane H-H′ shown in FIG. 1. FIG. 3 is a schematic circuit diagram of various elements, wires, and the like provided in a plurality of pixels arranged in a matrix in an image display region of a liquid crystal display device, and FIG. 4 is a partial, enlarged, cross-sectional view of a liquid crystal display device. In the figures used for illustration, in order to recognize individual layers and constituent elements in the figure, the reduction scales thereof differ from each other.

In FIGS. 1 and 2, a liquid crystal display device 100 of this exemplary embodiment has a structure in which a TFT array substrate 10 and a counter substrate 20 are bonded to each other with a sealing material 52, and liquid crystal 50 is enclosed and held in a region defined by this sealing material 52. The sealing material 52 is formed to have a closed frame shape on the region of the surface of the substrate and is not provided with a liquid crystal inlet therein, and hence a plug material used to provide plugging is not provided.

Inside the region defined by the sealing material 52, a peripheral delimiter 53 composed of a shading material is formed. In a region outside the sealing material 52, a data line drive circuit 201 and mounting terminals 202 are formed along one side of the TFT array substrate 10, and along the two sides adjacent to the above-mentioned side, scanning line drive circuits 204 are formed. Along the remaining side of the TFT array substrate 10, a plurality of wires 205 are provided which connect the scanning line drive circuits 204 formed on both sides of the image display region to each other. In addition, at least one location of the corner portions of the counter substrate 20, a conduction material 206 is provided to electrically connect the TFT array substrate 10 to the counter substrate 20.

Instead of the data line drive circuit 201 and the scanning line drive circuit 204 provided on the TFT array substrate 10, for example, a TAB (Tape Automated Bonding) substrate provided with a drive LSI thereon may be electrically and mechanically connected to terminals formed at the peripheral portion of the TFT array substrate 10 via an anisotropic film. In the liquid crystal display device 100, a retardation film, a polarizer, and the like are provided in predetermined directions in accordance with types of liquid crystal 50, that is, in accordance with an operation mode, such as a TN (Twisted Nematic) mode or an STN (Super Twisted Nematic) mode, or with a normally-white mode or a normally-black mode. However, they are omitted in the figures.

In addition, when the liquid crystal display device 100 is formed for the purpose of color display, on the counter substrate 20, for example, color filters of red (R), green (G), and blue (B) are formed together with a protection film in regions opposing individual pixel electrode regions described below of the TFT array substrate 10.

In the image display region of the liquid crystal display device 100 having the structure described above, as shown in FIG. 3, a plurality of pixels 100a are arranged in a matrix, TFTs 30 to provide pixel switching are formed in the individual pixels 100a, and data lines 6a to supply image signals S1, S2, . . . , and Sn are electrically connected to sources of the TFTs 30. The image signals S1, S2, . . . , and Sn to be written in the data lines 6a may be supplied in that order in a line sequential manner or may be supplied to each group formed of the data lines 6a adjacent to each other. In addition, scanning lines 3a are connected to gates of the TFTs 30, and scanning signals G1, G2, . . . , and Gm in the form of pulse are applied to the scanning lines 3a in that order in a line sequential manner.

The pixel electrodes 9 are electrically connected to drains of the TFTs 30, and by putting the TFTs 30 used as a switching element in an ON state for a predetermined period of time, the image signals S1, S2, . . . , and Sn supplied from the data lines 6a are written in the individual pixels at predetermined timings. The image signals S1, S2, . . . , and Sn having a certain level and being written in the liquid crystal through the pixel electrodes 9 are retained for a predetermined period of time with a counter electrode 21 of the counter substrate 20 shown in FIG. 2. In addition, in order to prevent the image signals S1, S2, . . . , and Sn thus retained from leaking, a storage capacitor 60 is additionally provided in parallel with a liquid crystal capacitor formed between the pixel electrode 9 and the counter electrode. For example, a voltage of the pixel electrode 9 is retained by the storage capacitor 60 for a period of time three orders of magnitude longer than a period of time during which a source voltage is applied. Accordingly, the properties of retaining charges are improved, and a liquid crystal display device 100 having a high contrast ratio can be realized.

FIG. 4 is a partial, enlarged, cross-sectional view of the liquid crystal display device 100, on the TFT array substrate 10 primarily formed of a glass substrate 10′, the pixel electrodes 9 made of transparent electrodes primarily composed of ITO (indium tin oxide) are formed in a matrix (see FIG. 3), and the TFTs 30 (see FIG. 3) to provide pixel switching are electrically connected to the respective pixel electrodes 9. In addition, along the longitudinal and the lateral boundaries of the pixel electrodes 9, the data lines 6a, the scanning lines 3a, and capacitor lines 3b are formed, and the TFTs 30 are connected to the data lines 6a and the scanning lines 3a. That is, the data line 6a is electrically connected to a highly doped source region 1a of the TFT 30 through a contact hole 8, and the pixel electrode 9 is electrically connected to a highly doped drain region of the TFT 30 through a contact hole 15 and a drain electrode 6b. In addition, on the surfaces of the pixel electrodes 9, an alignment film 12 which is primarily composed of a polyimide resin and which is processed by rubbing is formed.

In addition, on a surface of a glass substrate 20′, at the TFT array substrate 10 side, of the counter substrate 20, a shading film 23 which is so-called black matrix or black stripe is formed so as to oppose the longitudinal and lateral boundary regions of the pixel electrodes 9 on the TFT array substrate 10, and on the surface of the shading film 23, the counter electrode 21 composed of an ITO film is formed. Furthermore, on the surface of the counter electrode 21, an alignment film 22 composed of a polyimide film is formed. Between the TFT array substrate 10 and the counter substrate 20, the liquid crystal 50 is enclosed between the substrates by the sealing material 52 (see FIG. 1).

The liquid crystal display device 100 having the structure described above includes the sealing material 52. In particular, the sealing material 52 contains a photocurable component and a thermosetting component. The photocurable component is primarily formed of an acrylic resin having a maximum curing rate of 60% to 95% (such as 85%), and the thermosetting component is primarily composed of an epoxy resin having a curing rate of 60% to 90% (such as 80%). In addition, the photocurable component may be primarily composed of a methacrylic resin, and furthermore, as the sealing material 52, a resin containing an acrylic group and an epoxy group in the same molecular chain may also be used.

A method for manufacturing the liquid crystal display device 100 is described below. In particular, among manufacturing steps, the formation of the sealing material, dripping of the liquid crystal, bonding of the substrates, and curing of the sealing material are described below.

As shown in FIG. 4, after the TFTs 30 are formed on the glass substrate 10′, the pixel electrodes 9, the alignment film 12, and the like are formed, thereby obtaining the TFT array substrate 10. In addition, the shading film 23, the counter electrode 21, the alignment film 22, and the like are formed on the glass substrate 20′ in that order, thereby forming the counter substrate 20. Subsequently, the closed frame shape (see FIG. 1) composed of an adhesive is formed on at least one of the TFT array substrate 10 and the counter substrate 20 (for example, on the TFT array substrate 10). In the case described above, a predetermined shape is formed by a drawing method using a dispenser.

Next, after spacers are scattered inside this frame-shaped adhesive, heating to a predetermined temperature is performed so that the spacers are fixed on the substrate, and liquid crystal is further dripped inside the frame-shaped adhesive using a dispenser. Subsequently, the substrates are bonded to each other in an evacuated state, and after the substrates are exposed to the air, the adhesive is cured. In this case, the curing of the adhesive includes a light irradiation substep of curing the photocurable component and a heating substep of curing the thermosetting component.

In the light irradiation substep, the amount of light irradiation is set to 1,000 to 6,000 mJ/cm² (such as 5,000 mJ/cm²). In addition, the heating temperature is set to 60 to 160° C. (such as 100° C.) in the heating substep, and the heating time is set to 20 to 300 minutes (such as 120 minutes). By the curing described above, the adhesive is cured, thereby forming the sealing material.

In the liquid crystal display device 100 of this exemplary embodiment manufactured by the manufacturing method including the steps described above, the sealing material 52 contains a thermosetting component and a photocurable component, the maximum curing rate of the photocurable component is set to 60% to 95%, and the curing rate of the thermosetting component is set to 60% to 90%. Accordingly, compared to the case in which the thermosetting component is only used, the curing can be performed in a short period of time, and compared to the case in which the photocurable component is only used, the strength can be increased. In addition, since the curing rates of the individual components are set to enhanced or optimal values, sufficient adhesion strength and sealing properties can both be obtained. Hence, a reliable liquid crystal display device having superior display performance and a small number of defect occurrences can be provided.

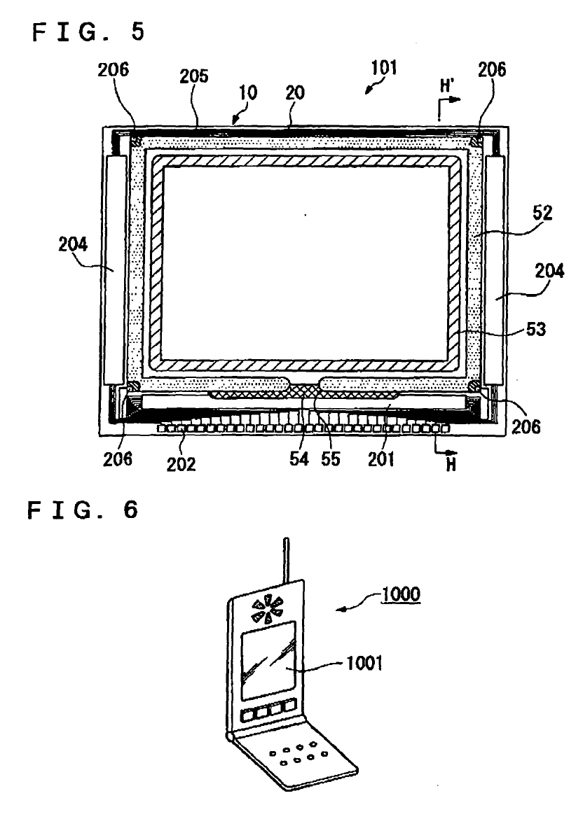

In addition to the closed frame-shaped sealing material of this exemplary embodiment, a resin containing a photocurable component and a thermosetting component as described above may be applied to a sealing material provided with a liquid crystal inlet. That is, sealing material 52 of a liquid crystal display device 101 shown in FIG. 5 has a liquid crystal inlet 55 which is used to inject liquid crystal after the TFT array substrate 10 and the counter substrate 20 are bonded to each other in manufacturing, and this liquid crystal inlet 55 is plugged with a plugging material 54 after the liquid crystal is injected. In the liquid crystal display device 101 described above, the liquid crystal is injected after the substrates are bonded to each other in manufacturing, and after the liquid crystal inlet is plugged, the sealing material is cured.

[Exemplary Electronic Apparatus]

Particular examples of electronic apparatuses that are each provided with the liquid crystal device of the above exemplary embodiment are described below.

FIG. 6 is a perspective view showing an example of a mobile phone. In FIG. 6, reference numeral 1000 indicates a mobile phone body, and reference numeral 1001 indicates a liquid crystal display portion using the liquid crystal device of the above exemplary embodiment.

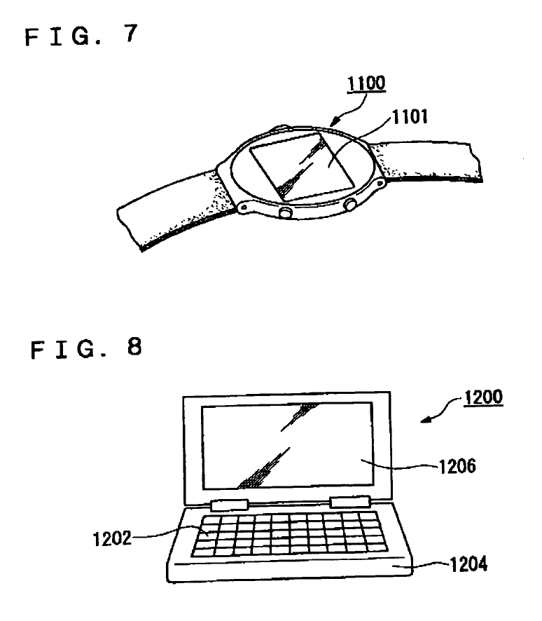

FIG. 7 is a perspective view showing an example of a wristwatch type electronic apparatus. In FIG. 7, reference numeral 1100 indicates a watch body, and reference numeral 1101 indicates a liquid crystal display portion using the liquid crystal device of the above exemplary embodiment.

FIG. 8 is a perspective view showing an example of a mobile information processing apparatus, such as a word processor or a personal computer, for example. In FIG. 8, reference numeral 1200 indicates an information processing apparatus, reference numeral 1202 indicates an input portion such as a keyboard, reference numeral 1204 indicates an information processing body, and reference numeral 1206 indicates a liquid crystal display portion using the liquid crystal device of the above exemplary embodiment.

Since the electronic apparatuses shown in FIGS. 6 to 8 are each provided with one of the liquid crystal devices according to the exemplary embodiments described above, a highly reliable electronic apparatus having superior display performance can be realized.

### EXAMPLES

Next, in order to confirm the performance of the liquid crystal device according to the present invention, the following examples were carried out.

### Example 1

First, for a liquid crystal display device of example 1, a resin containing an acrylic group as a photocurable component and an epoxy group as a thermosetting component was used as an adhesive, and a closed frame-shaped sealing material without a liquid crystal inlet was formed by using a dispenser. In particular, the adhesive was applied by a dispenser onto a glass substrate 370 mm wide and 470 mm long to form a predetermined pattern, and spacers made of a resin to provide fixing were scattered at a density of 100 pieces/mm² and were then heated to 100° C. for 10 minutes so as to be fixed on the surface of the substrate. Subsequently, liquid crystal was dripped inside the frame-shaped adhesive printed on the substrate by using a dispenser, and substrates were bonded to each other in an evacuated state so as to have a cell gap of 4 μm.

After the bonding, the substrates were exposed to an atmospheric pressure, and the surface of the substrate was irradiated with ultraviolet rays by a high pressure mercury lamp having an output of 100 mW/cm² (365 nm) used as a UV irradiator, followed by heating in an oven. In addition, by changing the UV irradiation time, heating time in the oven, and heating temperature, sealing materials having different maximum curing rates (%) of the acrylic group and different curing rates (%) of the epoxy group were formed, as shown in Tables 1 to 3. After the curing by the UV irradiation and the heating described above, an STN panel (with no color filters) having a diagonal line 2 inches long was obtained by cutting, thereby forming a liquid crystal display device having the structure shown in FIG. 1. For the liquid crystal display devices thus formed, a seal strength test, a reliability evaluation, and a cell gap inspection were performed, and the rates of defect occurrences (%) of the liquid crystal display devices having different curing rates (%) were measured.

The seal strength test was performed in accordance with JIS R1601. Although the loading speed in accordance with JIS R1601 is 0.5 nm/minute, in this example, the loading speed was set to 0.1 mm/second. After 10 seconds from the start of the loading, that is, after 1.0 mm was loaded, the sample was held for 10 seconds in that state, and the rate of occurrence (%) of seal peeling was then measured. The results are shown in Table 1.

In the reliability evaluation, after the sealing material was placed for 500 hours in a state in which the temperature and the humidity were set to 60° C. and 90%, respectively, the rate of defect occurrence (%) was measured which was caused by moisture passing through the sealing material. The results are shown in Table 2.

In addition, as the cell gap inspection, the cell gap uniformity in the panel obtained by cutting was inspected after heating, and the rate of occurrence (%) of cell gap defects was measured. In this inspection, an in-plane cell gap in the range of more than 0.05 μm was categorized in the cell gap defect. The results are shown in Table 3.

TABLE 1

| | | Acrylic Component, Maximum Curing Rate | | | | | | | | |
|---|---|---|---|---|---|---|---|---|---|---|
| | | 50 | 55 | 60 | 70 | 80 | 90 | 95 | 97 | 99 |
| Epoxy | 50 | 0 | 0 | 0 | 0 | 0 | 0 | 0 | 1 | 1 |
| Component | | | | | | | | | | |
| Curing Rate | | | | | | | | | | |
| | 55 | 0 | 0 | 0 | 0 | 0 | 0 | 0 | 2 | 2 |
| | 60 | 0 | 0 | 0 | 0 | 0 | 0 | 0 | 2 | 2 |
| | 70 | 0 | 0 | 0 | 0 | 0 | 0 | 0 | 3 | 4 |
| | 80 | 0 | 0 | 0 | 0 | 0 | 0 | 0 | 5 | 5 |
| | 90 | 0 | 0 | 0 | 0 | 0 | 0 | 0 | 8 | 12 |
| | 95 | 3 | 3 | 3 | 4 | 4 | 7 | 10 | 17 | 30 |

TABLE 2

| | | Acrylic Component, Maximum Curing Rate | | | | | | | | |
|---|---|---|---|---|---|---|---|---|---|---|
| | | 50 | 55 | 60 | 70 | 80 | 90 | 95 | 97 | 99 |
| Epoxy | 50 | 5 | 5 | 5 | 5 | 4 | 4 | 4 | 3 | 3 |
| Component | | | | | | | | | | |
| Curing Rate | | | | | | | | | | |
| | 55 | 3 | 2 | 2 | 2 | 1 | 1 | 1 | 1 | 1 |
| | 60 | 0 | 0 | 0 | 0 | 0 | 0 | 0 | 0 | 0 |
| | 70 | 0 | 0 | 0 | 0 | 0 | 0 | 0 | 0 | 0 |
| | 80 | 0 | 0 | 0 | 0 | 0 | 0 | 0 | 0 | 0 |
| | 90 | 0 | 0 | 0 | 0 | 0 | 0 | 0 | 0 | 0 |
| | 95 | 0 | 0 | 0 | 0 | 0 | 0 | 0 | 0 | 0 |

TABLE 3

| | | Acrylic Component, Maximum Curing Rate | | | | | | | | |
|---|---|---|---|---|---|---|---|---|---|---|
| | | 50 | 55 | 60 | 70 | 80 | 90 | 95 | 97 | 99 |
| Epoxy | 50 | 7 | 3 | 0 | 0 | 0 | 0 | 0 | 0 | 0 |
| Component | | | | | | | | | | |
| Curing Rate | | | | | | | | | | |
| | 55 | 8 | 4 | 0 | 0 | 0 | 0 | 0 | 0 | 0 |
| | 60 | 8 | 4 | 0 | 0 | 0 | 0 | 0 | 0 | 0 |
| | 70 | 8 | 4 | 0 | 0 | 0 | 0 | 0 | 0 | 0 |
| | 80 | 8 | 5 | 0 | 0 | 0 | 0 | 0 | 0 | 0 |
| | 90 | 7 | 4 | 0 | 0 | 0 | 0 | 0 | 0 | 0 |
| | 95 | 8 | 4 | 0 | 0 | 0 | 0 | 0 | 0 | 0 |

As shown in Table 1, as for the seal strength, when the curing rate of the epoxy group (epoxy component) was 95%, the strength decreased in some cases, and in addition, when the maximum curing rate of the acrylic group (acrylic component) was more than 97%, the strength also decreased in some cases. In addition, when the curing rate of the epoxy group was 50% to 90%, and when the maximum curing rate of the acrylic group was 50% to 95%, superior results were obtained for the seal strength.

As shown in Table 2, as for the reliability evaluation, when the curing rate of the epoxy group was 55% or less, excessive moisture absorption occurred in some cases. On the other hand, when the curing rate of the epoxy group was 60% to 95%, regardless of the maximum curing rate of the acrylic group, superior results were obtained for the reliability evaluation.

As shown in Table 3, as for the rate of occurrence of cell gap defects, when the maximum curing rate of the acrylic group was 55% or less, the in-plane cell gap was more than 0.05 μm in some cases. On the other hand, when the maximum curing rate of the acrylic group was more than 60%, regardless of the curing rate of the epoxy group, superior results were obtained for the evaluation of the rate of occurrence of the cell gap defects.

For comparison, the rate of occurrence of seal strength defects of a liquid crystal device was measured, in which the sealing material thereof is formed only of an acrylic component. In particular, the sealing material formed only of an acrylic component contained a UV curing agent and a granulated heat curing agent as a curing agent. The curing was carried out by irradiation with ultraviolet rays at 1,500 mJ/cm² so that the maximum curing rate was increased to approximately 50%, followed by adjusting a heating time at 120° C., thereby obtaining a predetermined curing rate. As described above, the rate of occurrence of seal strength defects was measured at each curing rate. The results are shown in Table 4.

TABLE 4

| | | | | | | | | | |
|---|---|---|---|---|---|---|---|---|---|
| Acrylic Component, | 50 | 55 | 60 | 70 | 80 | 90 | 95 | 97 | 99 |
| Maximum | | | | | | | | | |
| Curing Rate | | | | | | | | | |
| Rate of Occurrence | 100 | 100 | 100 | 100 | 100 | 97 | 95 | 94 | 94 |
| of Seal | | | | | | | | | |
| Strength Defects | | | | | | | | | |

As described above, when the sealing material was formed only of an acrylic type, it is understood that, in particular in a region in which the curing rate is low, a sufficient seal strength cannot be obtained.

In addition, the rate of defect occurrences (Table 5) in the reliability evaluation and the rate of occurrence (Table 6) of seal strength defects of a liquid crystal device were measured, in which the sealing material thereof was formed only of an epoxy component. In particular, after irradiation with ultraviolet rays at 100 mW/cm² was performed by changing the irradiation time to obtain different curing rates, the rate of defect occurrence (Table 5) in each curing rate and the rate of occurrence (Table 6) of seal strength defects were measured.

TABLE 5

| | | | | | | | |
|---|---|---|---|---|---|---|---|
| Curing Rate | 50 | 55 | 60 | 70 | 80 | 90 | 95 |
| Start | 90 | 83 | 70 | 38 | 20 | 14 | 8 |
| 100 hours from Start | 100 | 100 | 100 | 100 | 100 | 100 | 100 |

TABLE 6

| | | | | | | | | |
|---|---|---|---|---|---|---|---|---|
| Curing Rate | 50 | 55 | 60 | 70 | 80 | 85 | 90 | 95 |
| Rate of Occurrence | 0 | 0 | 0 | 0 | 1 | 4 | 30 | 50 |

In the case in which the sealing material formed only of a photocurable epoxy component was used as described above, when the curing rate was low, the number of defect occurrences in the reliability evaluation was large at the start, and when the curing rate was high, the rate of occurrence of seal strength defects tended to be high. Hence, it is understood that the reliability and the seal strength are difficult to obtain at the same time when the epoxy component is only used.

From the comparative examples described above, it is understood that a sufficient strength cannot be obtained when the acrylic component is only used, and that when the epoxy component is only used, the reliability and the seal strength are difficult to obtain at the same time.

According to the results described above, when the sealing material is formed by using a resin containing an epoxy group and an acrylic group, in which the curing rate of the epoxy group is set to 60% to 90% and the maximum curing rate of the acrylic group is set to 60% to 95%, it is understood that a highly reliable liquid crystal display device having superior sealing properties in addition to a superior strength can be provided.

### Example 2

Next, a liquid crystal display device of example 2 was formed by using a sealing material equivalent to that of example 1, and the shape of the sealing material was formed by using a dispenser so as to have a liquid crystal inlet therein. In example 2, in order to cure the acrylic component, irradiation with ultraviolet rays was performed under the same conditions as those in example 1, and in order to cure the epoxy component, heating was performed under the same conditions as those in example 1. In addition, for this formation, the other conditions were also the same as those in example 1. For the liquid crystal devices obtained in example 2, the seal strength test (Table 7), the reliability evaluation (Table 8), and the cell gap inspection (Table 9) were performed, and the rates of defects (%) of the liquid crystal devices having different curing rates (%) were measured.

TABLE 7

| | | Acrylic Component, Maximum Curing Rate | | | | | | | | |
|---|---|---|---|---|---|---|---|---|---|---|
| | | 50 | 55 | 60 | 70 | 80 | 90 | 95 | 97 | 99 |
| Epoxy | 50 | 0 | 0 | 0 | 0 | 0 | 0 | 0 | 1 | 1 |
| Component | | | | | | | | | | |
| Curing Rate | | | | | | | | | | |
| | 55 | 0 | 0 | 0 | 0 | 0 | 0 | 0 | 2 | 2 |
| | 60 | 0 | 0 | 0 | 0 | 0 | 0 | 0 | 3 | 2 |
| | 70 | 0 | 0 | 0 | 0 | 0 | 0 | 0 | 3 | 4 |
| | 80 | 0 | 0 | 0 | 0 | 0 | 0 | 0 | 4 | 6 |
| | 90 | 0 | 0 | 0 | 0 | 0 | 0 | 0 | 6 | 11 |
| | 95 | 2 | 3 | 3 | 4 | 5 | 8 | 12 | 15 | 28 |

TABLE 8

| | | Acrylic Component, Maximum Curing Rate | | | | | | | | |
|---|---|---|---|---|---|---|---|---|---|---|
| | | 50 | 55 | 60 | 70 | 80 | 90 | 95 | 97 | 99 |
| Epoxy | 50 | 5 | 5 | 5 | 4 | 4 | 4 | 3 | 3 | 3 |
| Component | | | | | | | | | | |
| Curing Rate | | | | | | | | | | |
| | 55 | 3 | 3 | 2 | 2 | 2 | 1 | 1 | 1 | 1 |
| | 60 | 0 | 0 | 0 | 0 | 0 | 0 | 0 | 0 | 0 |
| | 70 | 0 | 0 | 0 | 0 | 0 | 0 | 0 | 0 | 0 |
| | 80 | 0 | 0 | 0 | 0 | 0 | 0 | 0 | 0 | 0 |
| | 90 | 0 | 0 | 0 | 0 | 0 | 0 | 0 | 0 | 0 |
| | 95 | 0 | 0 | 0 | 0 | 0 | 0 | 0 | 0 | 0 |

TABLE 9

| | | Acrylic Component, Maximum Curing Rate | | | | | | | | |
|---|---|---|---|---|---|---|---|---|---|---|
| | | 50 | 55 | 60 | 70 | 80 | 90 | 95 | 97 | 99 |
| Epoxy | 50 | 7 | 4 | 0 | 0 | 0 | 0 | 0 | 0 | 0 |
| Component | | | | | | | | | | |
| Curing Rate | | | | | | | | | | |
| | 55 | 7 | 4 | 0 | 0 | 0 | 0 | 0 | 0 | 0 |
| | 60 | 7 | 4 | 0 | 0 | 0 | 0 | 0 | 0 | 0 |
| | 70 | 7 | 4 | 0 | 0 | 0 | 0 | 0 | 0 | 0 |

According to the results described above, in the case in which the liquid crystal inlet is formed in the sealing material and liquid crystal is injected after the substrates are bonded to each other, when the sealing material is formed by using a resin containing an epoxy group and an acrylic group, in which the curing rate of the epoxy group is set to 60% to 90% and the maximum curing rate of the acrylic component is set to 60% to 95%, as is the case of example 1 in which the liquid crystal inlet is not formed, it is understood that a highly reliable liquid crystal display device having superior sealing properties in addition to a superior strength can be provided.

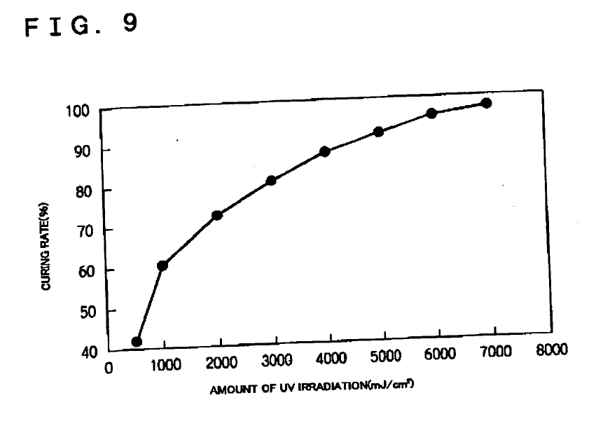

In addition, when the maximum curing rate of an acrylic resin was measured with the amount of ultraviolet ray irradiation, the results shown in FIG. 9 were obtained. From these results, it is understood that when the curing rate is set to 60% to 95%, the amount of ultraviolet ray irradiation must be set to 1,000 to 6,000 mJ/cm².

In addition, in examples 1 and 2, a monochrome panel was used, and hence in irradiation with ultraviolet rays, the entire sealing material was irradiated with ultraviolet rays. However, when a color panel is used, inconveniences may occur in some cases in which parts of a sealing material (adhesive) are not sufficiently irradiated with ultraviolet rays because of the presence, for example, of the color filters on one substrate and metal wires on the other substrate. However, since it is sufficient that the curing rate of the acrylic component obtained by irradiation with ultraviolet rays, that is, the maximum curing rate, may be from 60% to 95%, even when a part having a curing rate of less than 60% is present, the cell gap is hardly influenced thereby. In addition, as spacers, although spherical resin-made spacers were scattered, photo spacers may be disposed on the substrate. Furthermore, the acrylic group was used as a photocurable component. However, a methacrylic group may be used instead.

As described above, according to the liquid crystal device of the present invention, since the sealing material contains a photocurable component and a thermosetting component, and the maximum curing rate of the photocurable component is set to 60% to 95% and the curing rate of the thermosetting component is set to 60% to 90%, the curing can be performed in a short period of time as compared to the case in which a thermosetting component is only used, and compared to the case in which a photocurable component is only used, the strength can be increased. In addition, since the curing rates of the individual components are set as described above, the adhesion strength and the sealing properties can be satisfactorily obtained at the same time.

What is claimed is:

1. A liquid crystal device comprising: a pair of substrates; a liquid crystal layer provided therebetween; and a sealing material bonding said pair of substrates to each other and enclosing the liquid crystal layer between said pair of substrates,
wherein the sealing material contains a photocurable component and a thermosetting component, the photocurable component has a maximum curing rate in the range of from 60% to 95%, and the thermosetting component has a curing rate in the range of from 60% to 90%.

2. The liquid crystal device according to claim 1, wherein the sealing material comprises a resin containing the photocurable component and the thermosetting component in the same molecular chain.

3. The liquid crystal device according to claim 1, wherein the sealing material comprises a resin containing the photocurable component, a resin containing the thermosetting component, and a resin containing the photocurable component and the thermosetting component in the same molecular chain.

4. The liquid crystal device according to claim 1, wherein the photocurable component comprises an acrylic group and/or a methacrylic group.

5. The liquid crystal device according to claim 1, wherein the thermosetting component comprises an epoxy group.

6. A method for manufacturing a liquid crystal device having a liquid crystal layer provided between a pair of substrates, the method comprising:
a step of applying an adhesive onto at least one of surfaces of said pair of substrates to form a closed frame shape in a region of the surface thereof;
a step of disposing spacers on at least one of surfaces of said pair of substrates;
a step of dripping liquid crystal onto at least one of surfaces of said pair of substrates after the adhesive and the spacers are disposed;
a step of bonding said pair of substrates to each other after the liquid crystal is dripped; and
a step of curing the adhesive after the bonding is performed,
wherein the adhesive is an uncured material which is formed to a sealing material according to claim 1 by curing.

7. A method for manufacturing a liquid crystal device having a liquid crystal layer provided between a pair of substrates, the method comprising:
a step of applying an adhesive onto at least one of surfaces of said pair of substrates to form a frame shape provided with a liquid crystal inlet;
a step of disposing spacers on at least one of surfaces of said pair of substrates;
a step of bonding said pair of substrates to each other after the adhesive and the spacers are disposed;
a step of curing the adhesive after the bonding is performed, and
a step of injecting liquid crystal inside the adhesive through the liquid crystal inlet;
wherein the adhesive is an uncured material which is formed to a sealing material according to claim 1 by curing.

8. The method for manufacturing a liquid crystal device, according to claim 6, wherein the step of curing the adhesive comprises a light irradiation substep of curing the photocurable component, and the amount of light irradiation in the light irradiation substep is 1,000 to 6,000 mJ/cm².

9. The method for manufacturing a liquid crystal device, according to claim 6, wherein the step of curing the adhesive comprises a heating substep of curing the thermosetting component, and the heating temperature and the heating time in the heating substep are set to 60 to 160° C. and 20 to 300 minutes, respectively.

10. An electronic apparatus comprising a liquid crystal device according to claim 1.
